(19) United States
(12) Patent Application Publication
(10) Pub. No.: US 2018/0330577 A1
(43) Pub. Date: Nov. 15, 2018

(54) VACUUM CRANE GAME WITH PERFORATED TARGETS

(71) Applicant: Stephen P. Shoemaker, JR., Redondo Beach, CA (US)

(72) Inventor: Stephen P. Shoemaker, JR., Redondo Beach, CA (US)

(21) Appl. No.: 15/593,033

(22) Filed: May 11, 2017

(51) Int. Cl. G07F 17/32; A63F 9/30; A63F 9/00

(52) U.S. Cl. CPC G07F 17/3297; G07F 17/3246; G07F 17/3248; A63F 2009/0081; A63F 9/30; A63F 9/0079; A63F 2250/144; G07F 17/3251

(57) ABSTRACT

A crane game with a vacuum head adapted to pick up objects with a smooth extraction surface is disclosed wherein the objects, or targets, include perforations that present a more challenging target by reducing the available extraction surface. Targets include one or more perforations that may prevent a seal from being formed with the suction head, denying extraction of the target by the vacuum head. Values may be assigned to the targets based on the number of perforations.

### BACKGROUND OF THE INVENTION

The present invention relates to amusement devices known as vacuum crane games, and more particularly to a vacuum crane game with targets having perforated surfaces such that the targets can be presented with varying difficulty in their acquisition and extraction.

Crane-type or “claw machine” arcade games are popular amusement devices often provided in game arcades, stores, or other public places. In these types of games, prize objects are provided within a closed housing and are viewable by a player through transparent glass or the like. Upon the insertion of a coin or other monetary input into the game, the player controls a mechanical claw or other grasping implement with a joystick, buttons, toggle switch, or the like. Typically, the claw is provided above the prize objects and the player can change the position of the claw over the prizes. The claw is then lowered toward the prizes upon activation by either automatically by a controller such as a computer or manually by the player, depending on the particular embodiment. The claw is either automatically opened when it reaches the level of the prizes or is opened under the player's control. After a predetermined amount of time, the claw may be automatically elevated. The claw may or may not be able to grasp a prize and hold onto the prize as the claw is raised. The controller then moves the claw over to a dispensing container and opens the claw, allowing the prize (if any is held) to drop into the dispensing chute and to be guided through the dispenser to an opening accessible to the player. In a common implementation, a sensor within the dispenser detects whether a prize has been won by the player. After the claw is opened over the dispenser, the controller moves the claw to its original starting position and waits for another insertion of the coin (unless the player is provided with multiple tries).

The prizes that the operator of a claw-type crane game can provide in the game are usually limited in selection due to the limitations of the mechanical claw. Since the claw must surround an object to be able to pick it up, most prizes in a claw-type crane game have been limited to large stuffed dolls or other soft, rough-surfaced merchandise that can be surrounded and grabbed by the claw fingers and raised from the supporting surface. Usually, flat, smooth or thin objects are not able to be picked up and held by the claw. However, a large number of flat, smooth, and thin objects are desirable to used as prizes in a crane-type game, such as smooth-surfaced spheres or eggshell containers, boxes, gumballs, cups, bulbs, trading cards, etc. Players desire to win these types of items and operators desire to provide them; however, the standard claw type mechanism cannot be used to pick them up.

One solution to the inability of claw-type cranes to pick up these objects is to provide a different type of pick-up device. One type of device that is used is a vacuum device that uses air suction to grab and hold an object. In U.S. Pat. No. 5,513,772 of Glaser, a vacuum embodiment of a crane pick-up game is disclosed in which a vacuum motor is suspended from a string and concealed by a facade or enclosure. The player may move the motor and lower the motor towards a field of prizes similarly to the claw in claw-type crane games. A spinning fan within the motor creates a suction force that is used to pick up and hold prizes. An orifice with a screen is used to prevent items from being sucked into the orifice. Prizes captured and held by the suction are dispensed to the player through a dispenser.

More recent vacuum crane games have improved on the concept and made the game more challenging. In my U.S. Pat. No. 5,855,374, a vacuum crane game is disclosed wherein the vacuum head is used to pick up one of the prizes using a suction force that is provided by a vacuum pump coupled to the vacuum head by a hose and located away from the vacuum head. Moving the pumping apparatus away from the crane head mechanism provides greater maneuverability than previous devices that carried the pumping equipment at the crane head. In general, the vacuum crane game is characterized by a vacuum pick up device positioned above the prize or target area and may be moved along a horizontal axis above the prize area. The pick up device includes a vacuum head that may be raised and lowered toward a turntable in a z-direction. The vacuum head is operative to pick up one of the prizes using a suction force that is provided by a vacuum pump coupled to the vacuum head by a hose. The vacuum pump is located away from the vacuum head to allow the vacuum head to move without interference. The player may control the movement of the pick up device to position the vacuum head over the prize area at a desired position, lower the vacuum head, and pick up a prize using the suction force. The pick up device is moved to a dispenser area and the suction force is removed to allow the prize to be dispensed to the player. The disclosure of my '374 patent is incorporated fully herein by reference. In another embodiment, the vacuum head may be moved in both x- and y-directions above the prize area and the turntable is omitted.

With vacuum crane games, it is desirable to provide prizes having smooth continuous surfaces such that a seal can be formed by the vacuum head against the prize. Without a complete seal, the vacuum head cannot effectively apply suction to the prize sufficiently to enable the prize to be lifted out of the prize bin. As a consequence, prizes such as jewelry, trading cards, candy, and toys are typically enclosed in transparent or opaque spheroids such as spheres and egg-shaped plastic containers. Such spheroids will have exteriors that meet the requirement of smooth, continuous surfaces allowing the vacuum head to make complete, sealing contact. An example of this type of prize collection for a vacuum crane game can be found in my U.S. Pat. No. 6,598,881, entitled “Crane Game with Prize Redistribution Mechanism” and incorporated herein fully by reference.

While the collection of spheroids in the prize bin of a vacuum crane game provides an enjoyable alternative to mechanical crane games that are used to pick-up irregularly shaped prizes, they take up a great deal of space and need to be replaced more often since fewer spheres can fit into a game space than smaller prizes. The trend has been to move toward more compact prizes, such as gift cards and redeemable tokens or coins. However, with these prizes it is difficult to differentiate the skill level to acquire the prizes, which tends to force the prizes to be all of the same value. To attract players, however, it is necessary to offer higher end prizes along with easier to acquire lesser value prizes. There is nothing in the gaming industry that provides for this feature.

### SUMMARY OF THE INVENTION

The present invention is characterized in a first preferred embodiment by a vacuum crane game with planar prizes having substantially smooth surfaces interrupted strategically with perforations or voids of varying number and positions to present prizes of varying capture difficulty. Because the flat vacuum crane head requires uninterrupted contact with the target to achieve an airtight seal, the crane game player must avoid the surface perforations or voids to pick up a target. If the vacuum head rests on one or more of the perforations or voids, no seal can be achieved and the capture of the target will be unsuccessful. Targets with more or larger perforations will be inherently more difficult to pick up than targets with fewer perforations, and with a variety of different targets having different hole configurations the game has challenges for all skill levels.

In a first embodiment, the target bin of a vacuum crane game is supplied with a plurality of gift cards or redeemable cards or tokens having smooth front and rear faces, and where the respective faces include perforations ranging from one to three or more spaced along the surface and of varying size. The prize value can be reflected by a numerical point value displayed on the card that can be applied to redeem prizes. The value of the reward is tied to the number and location of the voids, where higher number of voids or centrally located voids correspond to a higher degree of difficulty due to a smaller available continuous surface, and such targets possess a higher prize redemption value.

Alternative prize sizes can be used, such as flat poker chips with numerical values printed thereon or transparent containers that hold a prize, where the container includes substantially flat surfaces with voids on the surfaces to add difficulty to the task of retrieving the target.

### BRIEF DESCRIPTION OF THE DRAWINGS

FIG. 1 is a perspective view of a vacuum crane game and target bin housing targets with perforated surfaces;

FIG. 2 in an enlarged, perspective view of a first preferred embodiment of a target of the vacuum crane game of FIG. 1;

FIG. 3 is an enlarged, perspective view of the embodiment of FIG. 2 showing the pick-up device on a perforation; and

FIGS. 4 and 5 are top views of variations of the target of FIG. 2 with multiple perforations and point values.

### DETAILED DESCRIPTION OF THE PREFERRED EMBODIMENTS

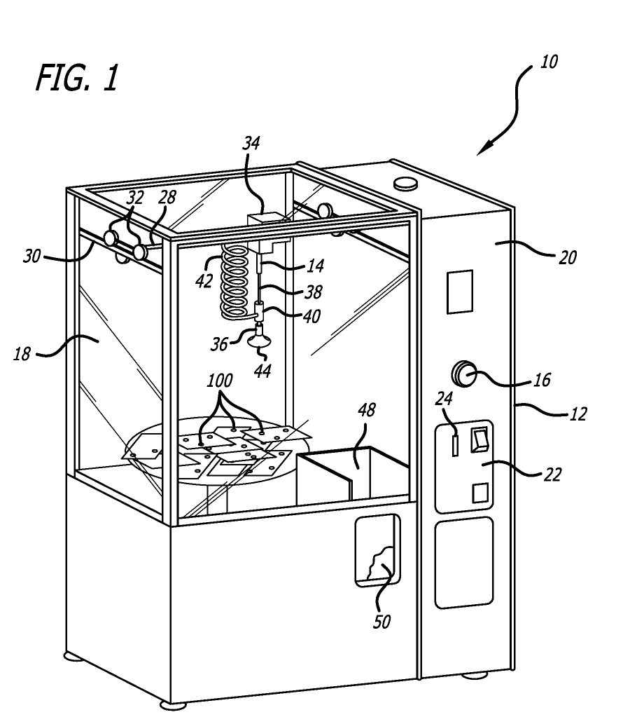

FIG. 1 is a perspective view of one embodiment of a game apparatus 10 in accordance with the present invention. Game apparatus 10 includes a housing 12, vacuum crane 14, player controls 16, and a target bin 18. The construction and operation of a vacuum crane game is known to one of ordinary skill in the art, and extensive discussion of the construction and operation of the vacuum crane game is omitted in favor of a brief overview for the sake of brevity.

A crane game 10 includes a housing 12 divided into two sections, a target bin 18 on a first half of the housing and a storage compartment 20 on the other half of the housing. The storage compartment 20 can enclose pumping equipment and the electronics to manipulate the vacuum crane 14 and produce any sounds or visual effects that accompany the game play. The storage compartment 20 can also provide a repository for surplus prizes or targets as the inventory in the target bin 18 is depleted. On the housing 12 is a control panel 22 including a slot 24 for receiving the tokens, coins, money, or game cards that initiates a game play. The control panel 22 further includes a controlling device such as a joystick or button 16, or the like for maneuvering the crane 14 within the target bin 18. The target bin 18 includes a boom 28 spanning its width and driven along two horizontal rails 30 on a set of rollers 32. Using the controlling device 16 to actuate an electrical motor, the boom 28 can be positioned along the path between the front and rear walls of the target bin.

In addition to controlling the position of the boom in the forward/rearward direction, a carriage assembly 34 rides on the boom 28 and translates across the boom 28 from the left side to the right side of the target bin 18. Once again, the controlling device 16 initiates movement of the carriage assembly 34 along the boom 28 such that, by manipulating the controlling device in a particular manner the carriage assembly 34 can be positioned substantially over any object in the target bin 18. The carriage assembly 34 is driven by an electric motor or other device that is controlled by the button 16, a joystick, touchpad, or other similar input device.

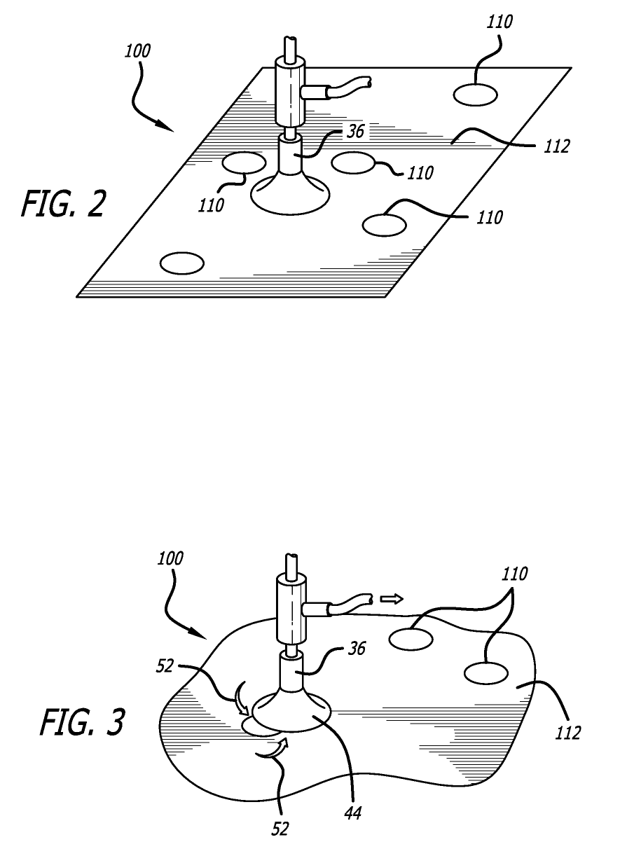

The crane assembly 14 includes a vacuum head 36 suspended as a crane by a retractable cable 38 and weight assembly 40, and further connected to a coiled suction line 42 leading to a pump (not shown), wherein suction from the pump is communicated through the suction line 42 to the distal end of the vacuum head 36. The head 36 includes a circular lip 44 or peripheral edge selected to mate with the respective upper surfaces of the targets 100 in the target bin 18 to form a substantially air-tight seal. When the vacuum head 36 is engaged with a target 100 in a sealing relationship (see FIG. 2) and suction is communicated to the vacuum head 36, the negative pressure inside the vacuum head will cause the target 100 to adhere to the peripheral lip 44 and be captured. As long as suction is maintained at the vacuum head 36 and the seal between the target 100 and the peripheral lip 44 is maintained, the captured target will remain held connected.

The vacuum crane game 10 may include a sensing mechanism (not shown) that determines when a target 100 has been captured by the vacuum head 36, and initiates an operation whereby the vacuum head 36 is raised above the collection of targets 100 and directed to an extraction chute 48 separated from the targets 100. The suction is automatically disconnected when the vacuum head 36 resides over the extraction chute 48, causing the captured target to fall into the extraction chute where it enters a compartment 50 that can be accessed by the player. The challenge for the skilled player is to identify a target 100 first and then using the controlling device 16 maneuver the vacuum head 36 appropriately until the peripheral lip 44 of the vacuum head 36 is directly above the selected target, and then the vacuum head is lowered onto the target 100 until mating results in capture and finally extraction.

As shown in FIGS. 2-5, in the present invention the targets 100 present additional challenges in that the targets' upper surface 112 is reduced by the presence of perforations 110 of varying size and number. The voids 110 increase the difficulty because the vacuum head 36 will be unable to achieve a seal against the target 100 if the vacuum head 36 is located such that the peripheral lip 44 partially or wholly covers the perforation (see FIG. 3). Thus, the target 100 will not be captured by the vacuum head 36 in this case. The player must therefore avoid the perforations 110 as he attempts to land the vacuum head 36 on the target's available extraction surface 112 (the uninterrupted smooth surface between or around the perforations). Adding additional perforations 110 further reduce the available extraction surface 112 and increase the difficulty, as will the strategic locating of the perforations 110 to break-up the largest extraction surface areas and the size of the perforations.

The targets themselves can take the form of playing cards, poker chips, redeemable gift cards, or other stackable thin prizes that can be perforated. Other shaped targets 100c are also possible.

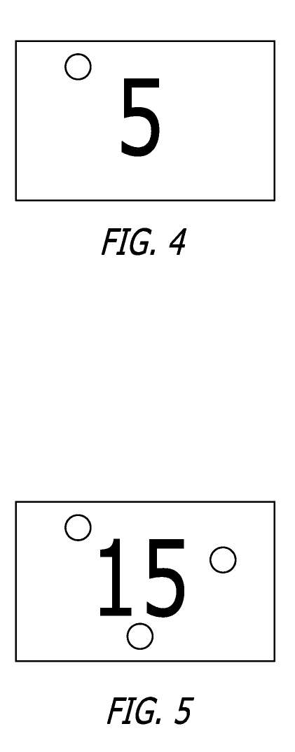

The shape of the perforation 110 is not limited and take any shape, although circular perforations are typically easier to impart on the prize. As shown in FIGS. 4 and 5, the number and placement of the perforations can result in a varying scale of difficulty assigned to the various targets, with a higher difficulty assigned to targets with two or more perforations and lower difficulty assigned to one. Furthermore, spacing can also affect the assigned difficulty level of the target. The difficulty level can then be used to determine the appropriate reward for successfully capturing and extracting the various targets. Each target is assigned a value of points that can be redeemed for prizes or other rewards, and the player is challenged to attempt to retrieve the most difficult targets and reap the greatest rewards or try the easier targets and accumulate points more slowly. The system provides much greater interest and intrigue to the amusement device.

As shown in FIGS. 2 and 3, when the vacuum head 36 comes into contact with the extraction surface 112 of the target 100 of the present invention, two possibilities are present. First, the player can maneuver the vacuum head 36 clear of the perforations 110 and create a sealing relation with the extraction surface 112, enabling the target 100 to be captured and extracted (FIG. 2). Alternatively, the vacuum head 36 can contact the extraction surface 112 such that the peripheral lip 44 of the vacuum head 36 resides on top of the perforation i.e., the perforation is partially or completely covered by the vacuum head 36 (FIG. 3). In this case, the suction at the vacuum head 36 is defeated by the open gap between the extraction surface 112 and the peripheral lip 44, as air represented by arrows 52 flows through the gap preventing adherence of the target 100 to the vacuum head 36. This prevents the target 100 from being captured and extracted. As more perforations 110 are added to a target, the available extraction surface 112 is reduced and the difficulty in maneuvering the vacuum head 36 to a suitable position for capture is increased.

As described above, the present invention increases the difficulty level of a crane game target 100 by introducing areas where suction against the surface of the target is rendered more difficult. The term “target” is used in the disclosure because the object to be picked up may be a prize, or it may be a holder for a marker or ticket reflecting a point value. Extraction of the holder allows the player to accumulate these markers for redemption at a designated location. The vacuum head 36 is typically conical with a circular base that allows objects with flat surfaces such as cards or poker chips, or the holders may also house a prize.

Although preferred embodiments have been described and depicted herein, the invention is not limited to those descriptions and depictions, and the scope of the invention includes the reasonable modifications and substitutions that would be recognized and appreciated by one of ordinary skill in the art in possession of the present disclosure. Accordingly, the scope of the invention is properly measured by the appended claims below, using their ordinary and customary meaning in light of, but not limited by, the descriptions herein.

1. A vacuum crane amusement apparatus having a target bin for housing a plurality of targets, a vacuum head including a peripheral lip at a first end for engaging a target in a sealing relationship, a pump for introducing suction at the peripheral lip to capture a sealingly engaged target, a control for maneuvering the vacuum head within the target bin, and an extraction chute for removing captured targets from the target bin, the apparatus further comprising:
a plurality of planar targets in the target bin having an extraction surface characterized by a smooth contour engageable with the peripheral lip of the vacuum head in a sealing relationship, the extraction surface further characterized by at least one perforation interrupting said smooth contour such that said perforation thwarts capture of the target by the vacuum head if disposed between the peripheral lip of the vacuum head and the extraction surface by preventing a sealing engagement therebetween.

2. The amusement device of claim 1 wherein the targets are gift cards.

3. The amusement device of claim 2 wherein the perforations on the target are varying sizes.

4. The amusement device of claim 3 wherein the targets differ in quantity of perforations.

5. The amusement device of claim 4 wherein the targets are assigned a redemption value corresponding to the quantity of perforations.
